(19) United States
(12) Patent Application Publication
(10) Pub. No.: US 2006/0227436 A1
(43) Pub. Date: Oct. 12, 2006

(54) Lens of image capture device

(76) Inventor: Wen Ching Chen, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/101,537

(22) Filed: Apr. 8, 2005

(51) Int. Cl. G02B 7/02

(52) U.S. Cl. 359/811

(57) ABSTRACT

A lens, which is made by injection molding, has a main member having a top side, a bottom side and a taper periphery between the top side and the bottom side. At least three protrusions are provided at the periphery of the main member, each of which has a distal side parallel to an axis of the main member and a protruding portion on the distal side respectively, wherein the protruding portions are located at a circumference. The axis of the main member is a center of the circumference, such that the main member has the distal sides of the protrusions attached on an interior sidewall of a lens barrel to have the main member and the lens barrel coaxial.

### BACKGROUND OF THE INVENTION

1. Field of the Invention

The present invention relates generally to a lens, and more particularly to a lens of an image capture device, which has a plurality of protrusions to press an interior sidewall of the lens barrel for precise positioning.

2. Description of the Related Art

As shown in FIG. 7 and FIG. 8, a conventional lens 8 is made of plastic by injection molding. The lens 8 has a taper periphery 81 with an angle θ and a cutoff portion 82 at the periphery 81, on which a feeding portion 83 is provided. The feeding portion 83 is where the plastic is fed thereto in the injection molding process.

The angle θ of the periphery 81 of the lens 8 is taper for the drawing mold procedure of the injection molding to prevent the lens 8 from being scrubbed and damaged in the drawing mold procedure. The cone periphery 81 of the lens 8 has less area to press an interior sidewall 91 of a lens barrel 9 that there is less resistance between the lens 8 and the lens barrel 9. As a result, the lens 8 is easy to be tilted, as shown in FIG. 9, with an axis a of the lens 8 deviated from a central line A of an image sensing member 92 that the image sensing member 92 can not focus an image accurately.

The cutoff portion 82 of the lens 8 provides a space for the feeding portion 83, which is a residual of the injection molding, not extruded, such that the feeding portion 83 does not interfere with the process of assembling the lens 8 in the lens barrel 9 firmly. A cavity 71 of a die 7 for injection molding of the lens 8 is not round because of the cutoff portion 82 of the lens 8 that an aspect of the cavity 71 has to be modified by computer, and the computer controls a cutting tool 6 to shape the die 7 having the cavity 71. But the computer is hard to make the periphery 81 having a constant curvature that the lens 8 can not be positioned in the lens barrel 9 at a precise location.

Aforesaid drawbacks of the conventional lens have to be fixed to have the precise positioning of the lens.

### SUMMARY OF THE INVENTION

The primary objective of the present invention is to provide a lens, which is provided with at least three protrusions at a periphery thereof. Distal sides of the protrusions are parallel to an axis of the lens, and distance between the distal sides of the protrusions and a center of the lens are equal. The lens has the distal sides of the protrusions rested on an interior sidewall of a lens barrel to have the axis of the lens align with an axis of the lens barrel, such that the lens is positioned precisely in the lens barrel

According to the objective of the present invention, a lens, which is made by injection molding, comprises a main member having a top side, a bottom side and a taper periphery between the top side and the bottom side. At least three protrusions are provided at the periphery of the main member. Each of the protrusions has a distal side parallel to an axis of the main member and a protruding portion on the distal side, which are located at a circumference. The axis of the main member is a center of the circumference.

### BRIEF DESCRIPTION OF THE DRAWINGS

FIG. 1 is a lateral view of a first preferred embodiment of the present invention;

FIG. 2 is a top view of the first preferred embodiment of the present invention;

FIG. 3 is a sectional view of the die molding the lens of the first preferred embodiment of the present invention;

FIG. 4 is another sectional view of the die molding the lens of the first preferred embodiment of the present invention;

FIG. 5 is a sectional view, showing the lens of the first preferred embodiment of the present invention installed in the lens barrel;

FIG. 6 is a top view of a second preferred embodiment of the present invention;

FIG. 7 is a lateral view of the conventional lens;

FIG. 8 is a top view of the conventional lens;

FIG. 9 is a sectional view, showing the conventional lens installed in the lens barrel, and

FIG. 10 is a top view of the die molding the conventional lenses.

### DETAILED DESCRIPTION OF THE INVENTION

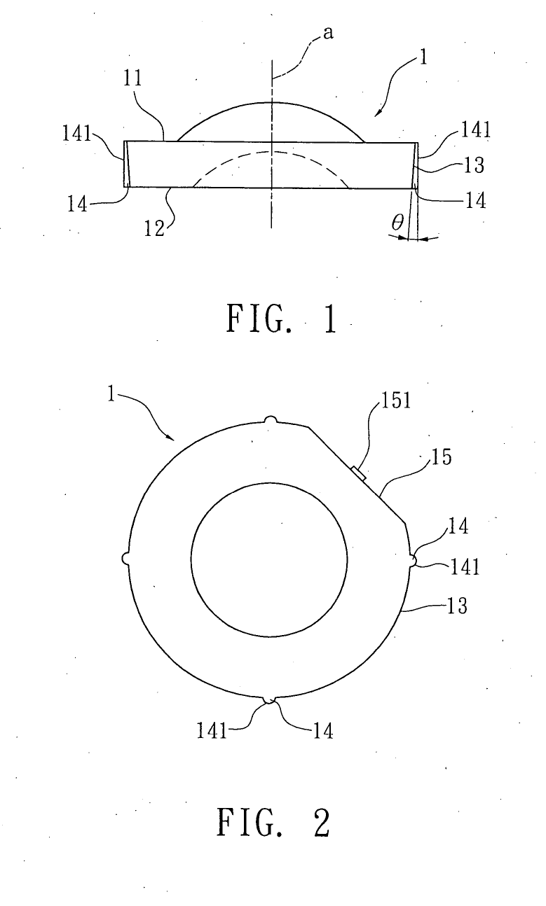

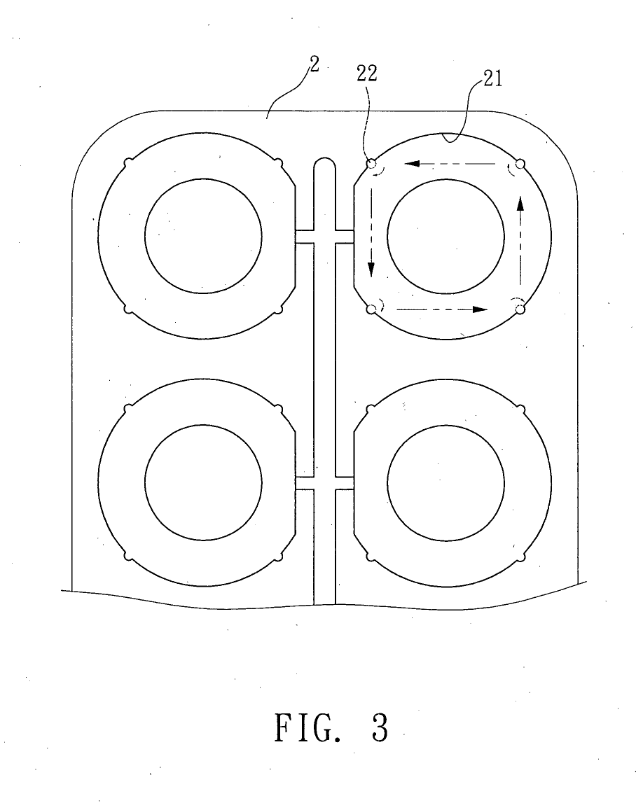

As shown in FIG. 1 and FIG. 2, a lens of the first preferred embodiment of the present invention is made by injection molding and has a main member 1 with a top side 11, a bottom side 12 and a periphery 13 between the op side 11 and the bottom side 12. The periphery 13 of the main member 1 is taper and has an angle θ. The main member 1 further has at least three protrusions 14 at the periphery 13 thereof, wherein there are four protrusions 14 in the present preferred embodiment. Each of the protrusions has a distal side 141 parallel to an axis a of the main member 1. Protruding portions of the distal sides 141 of the protrusions 14, which have the greater distance from the center of the main member 1, are located at a circumference, which a center of the main member 1 is a center of the circumference. The main member 1 further has a cutoff portion 15 at the periphery 13, on which a feeding portion 151 is provided, which is a residual of injection molding.

The protrusions 14 are more distal than the periphery 13. In the fabrication of a cavity 21 of a die 2, portions of the cavity 21 associated with the protrusions 14 are precisely calculated by computer to have linear paths of a cutting tool 22. The distal sides 141 of the protrusions 14 are parallel to the axis of the main member 1, such that the periphery 13 is not the portion of the main member 1 to be attached on a interior sidewall 31 of a lens barrel 3 rather than the periphery 13 therefore it doesn't have to control the curvature of the periphery 13 precisely. That reduces the cost of fabrication.

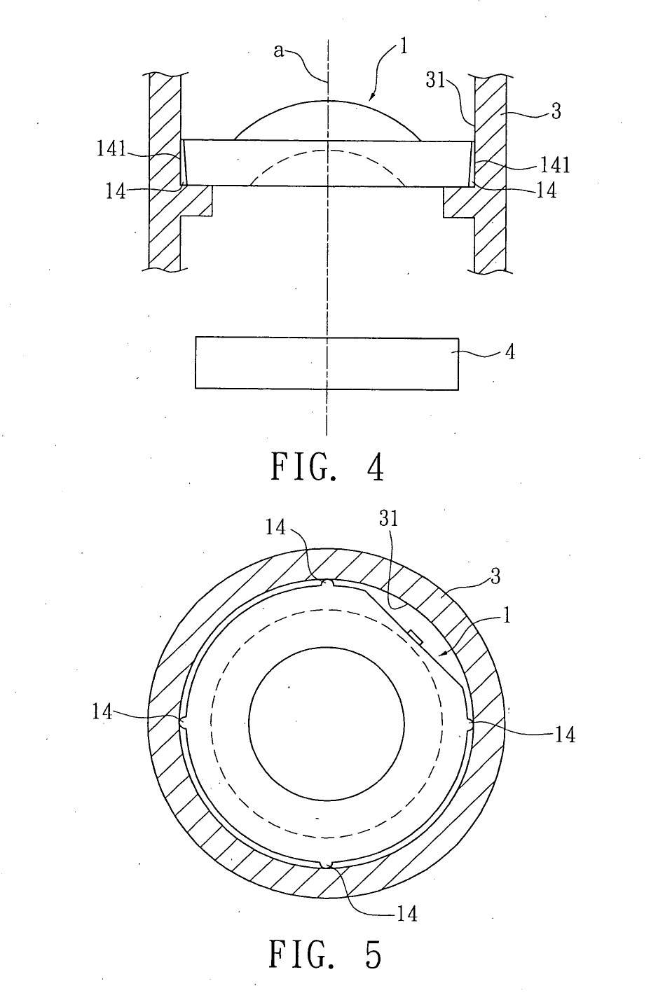

The distal sides 141 of the protrusions 14 are parallel to the axis a of the main member 1, the most protruding portions of the distal sides 141 of the protrusions 14 are located at the circumference, so that the lens of the present invention has the distal sides 141 of the protrusions attached on the interior sidewall 31 of the lens barrel 3, as shown in FIG. 4, to make sure that the main member 1 and the lens barrel 3 are coaxial. As a result, the axis of the main member 1 is aligned with a center of a sensing area of an image sensing member 4 to have the lens having a precise location relative to the image sensing member.

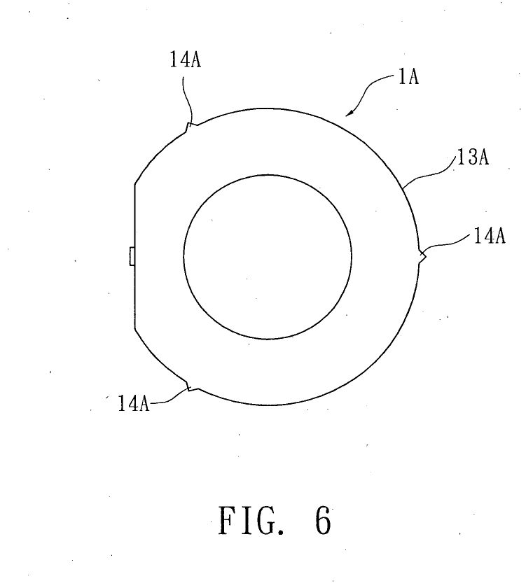

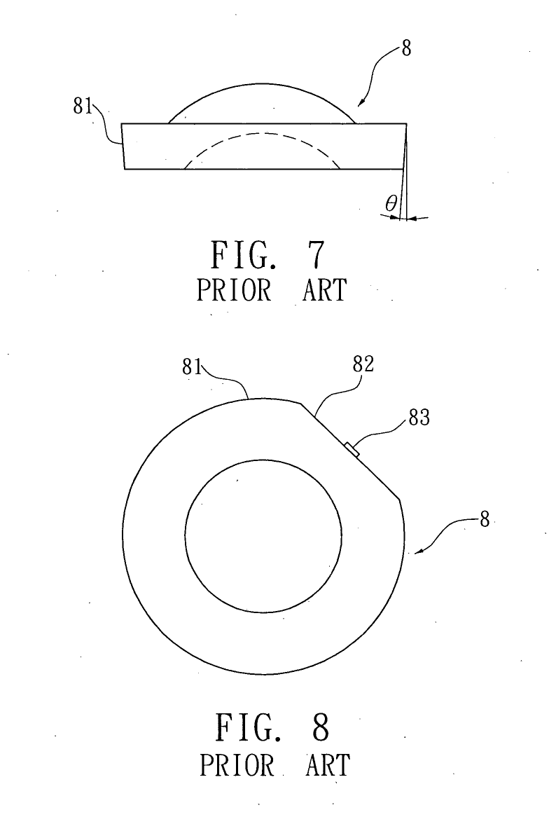

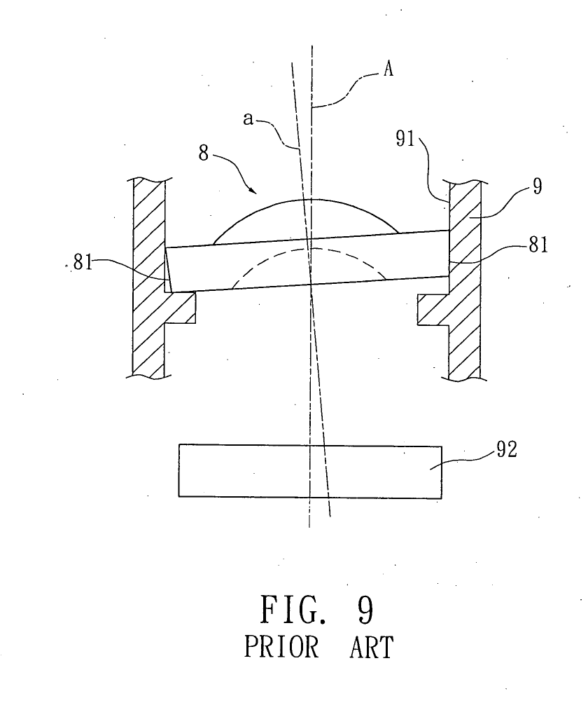

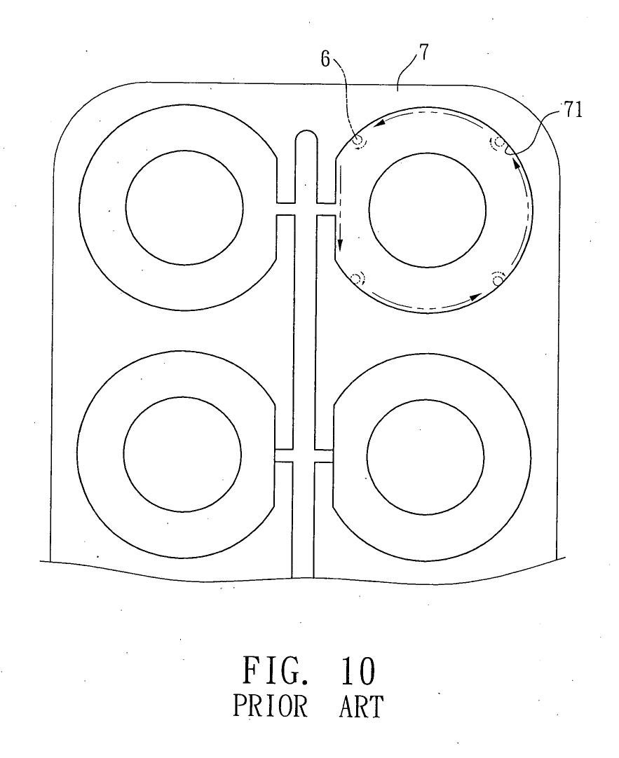

FIG. 6 shows a lens of the second preferred embodiment of the present invention, which has a main member 1A with three protrusions 14A at a periphery 13A thereof. The protrusions 14A are triangles in the second preferred embodiment, such that each of the protrusions 14A has a tip portion at a distal side thereof to serve a function as same as the lens of the first preferred embodiment.

Except for the injection molding as described above, the lens of the present invention may be made from molding or compression molding. A material made of the lens of the present invention may be plastic, macromolecule polymer, or glass.

What is claimed is:

1. A lens, which is made by molding, comprising a main member having a top side, a bottom side and a taper periphery between the top side and the bottom side; at least three protrusions provided on the periphery, each of the protrusions has a distal side parallel to an axis of the main member and a protruding portion located at a circumference, wherein the axis of the main member is a center of the circumference.

2. The lens as defined in claim 1, wherein the distal sides of the protrusions are curved.

3. The lens as defined in claim 1, wherein each of the distal sides of the protrusions has at least a tip portion.

4. The lens as defined in claim 1, wherein a method of making the lens is selected from molding, injection molding or compression molding.

5. The lens as defined in claim 1, wherein the main member has a cutoff portion on the periphery thereof, on which a feeding portion, which is a residual of the injection molding, is provided.

6. The lens as defined in claim 4, wherein a material made of the lens is selected from plastic, macromolecule polymer or glass.
